(19) United States
(12) Patent Application Publication
(10) Pub. No.: US 2012/0078385 A1
(43) Pub. Date: Mar. 29, 2012

(54) SMART ELECTRONIC CONNECTING DEVICE

(75) Inventor: YING-CHANG LIU, TAIPEI COUNTY (TW)

(73) Assignee: PRODIGIT ELECTRONICS CO., LTD., TAIPEI COUNTY (TW)

(21) Appl. No.: 13/159,532

(22) Filed: Jun. 14, 2011

(30) Foreign Application Priority Data
Sep. 24, 2010 (TW) 99132299

(51) Int. Cl. G05B 11/01

(52) U.S. Cl. 700/14

(57) ABSTRACT

A smart electronic connecting device applicable to control the electronic connection between an external power supply and an external electronic connector includes an input unit connected to the external power supply, a processing module, a mode generation unit, an output unit and a relay unit connected between the input unit and the output unit. The processing module has a timing generation unit generating a timing signal, a control unit generating a control signal, and a memory unit. The mode generation unit generates multiple mode selecting signals to the control unit. The output unit is to connected to the external electronic connector. The relay unit is turned on/off selectively according to the control signal of the control unit to conduct the input unit and the output unit, wherein the memory unit records the turn-on connection status of the relay unit within the predetermined period to recur the turn-on connection status.

### BACKGROUND

1. Field of Invention

The present invention relates to a smart electronic connecting device. More particularly, the present invention relates to a smart electronic connecting device with smart learning function to control an electrical socket to provide the electricity or not.

2. Description of Related Art

Traditionally, timing control function is widely used in the electrical products to save energy effectively or reserve control according to the settings of a user. Generally speaking, the user can formally set timing control just according to the predetermined time, for example 1 hour, two hours to 24 hours etc. . . . , which is set by the manufacturers to the electrical products.

As the demand for customized, the manufacturers further provide the timing device with learning the habit of the user to automatically enable the timing control at the predetermined time according the above-mentioned preferred setting of the user. However, the above-mentioned timing control is to automatically enable just according to the predetermined time set by the user to enable such that it is still inconvenient. For example, in the prior technology, if the user enable the electrical product at 12 o'clock and set the usage time as 2 hours preset by the manufacturer, the electrical product will be enabled for 2 hours at 12 o'clock next day such that this learning method is still simple and inelastic.

A smart learning device provided by the present invention can provide smart operating management in any electrical product effectively and flexibly.

### SUMMARY

The present invention aims to provide a smart electronic to connecting device by intelligently learning the operating habit of the user to achieve the goal of imitating the user for operating the electronic connecting device.

In order to achieve the aforementioned object, a technical aspect of the present invention relates to a smart electronic connecting device applicable to control the electronic connection between an external power supply and an external electronic connector. The smart electronic connecting device includes an input unit, a processing module, a mode generation unit, an output unit and a relay unit. The input unit is connected to the external power supply. The processing module includes a timing generation unit, a control unit and a memory unit, wherein the processing module is electrically connected to the relay unit, the timing generation unit generates a timing signal, and the control unit generates a control signal. The mode generation unit is connected to the processing module, and the mode generation unit generates multiple mode selecting signals to the control unit. The output unit is connected to the external electronic connector. The relay unit is connected between the input unit and the output unit, and the relay unit is turned on/off selectively according to the control signal of the control unit to conduct the input unit and the output unit, wherein the memory unit records the turn-on connection status of the relay unit within the predetermined period, and recurs the turn-on connection status in one mode corresponding to one signal of the mode selecting signals.

In compared with the prior art, this present invention provides a smart electronic connecting device for the user to control an electronic connecting unit by manual control, learning control and smart control. In another word, besides the electronic connecting unit can be manually controlled to conduct or not, the electronic connecting unit can also recur the operation habit of the user automatically by way of learning. While the status is automatically in smart control, the user can still temporarily or completely interrupt the smart control procedure by manual control at any time, and while the user stops the manual control, the smart control procedure can resume again processing the smart control continuously. Further, while the external power supply powers off, the electricity stored in the internal power storage unit can be provided to the smart electronic connecting device to operate to not lose the operation mode which has been stored. Besides, the timing of the present invention can be obtained from the internal timing generator, and the timing can also be obtained from the frequency of the external power supply as the reference of timing. The indicating device can indicate the manual control mode, the learning control mode and the smart control mode etc. . . . .

### BRIEF DESCRIPTION OF THE DRAWINGS

The following objectives, features, advantages and embodiments of the present invention can be more fully understood, with reference made to the accompanying drawings as follows:

FIG. 1 and FIG. 2 are the block diagrams of a smart electronic connecting device according to the first embodiment of the present invention;

FIG. 3, FIG. 4 and FIG. 5 are the block diagrams of a smart electronic connecting device according to the second embodiment of the present invention;

FIG. 6 is a block diagram of a smart electronic connecting device according to the first embodiment of the present invention;

FIG. 7 is a flow chart of the method of the present invention

FIG. 8A, FIG. 8B and FIG. 8C are the operating status diagrams of the present invention in the manual control mode, the learning control mode and the smart control mode respectively; and

FIG. 9 is a switching diagram of the present invention among the manual control mode, the learning control mode and the smart control mode.

### DETAILED DESCRIPTION

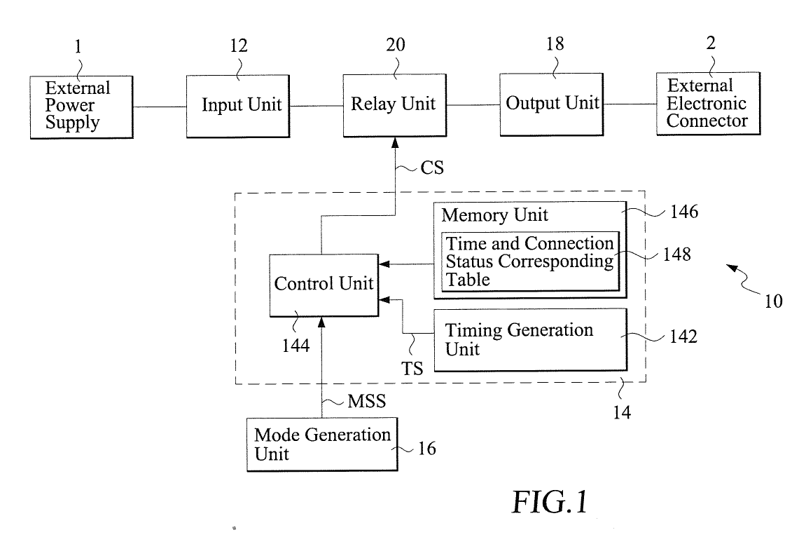

Referring to FIG. 1, FIG. 1 is a block diagram of a smart electronic connecting device according to the first embodiment of the present invention. In this embodiment, the smart electronic connecting device 10 applicable to control electronic connection between the external power supply 1 and the external electronic connector 2 includes a input unit 12, a processing module 14, a mode generation unit 16, an output unit 18 and a relay unit 20, wherein the external power supply 1 is usually AC mains with 50 Hz or 60 Hz frequency, and the external electronic connector 2 is usually corresponding to the electronic connecting device. For example, when the output of electronic connecting device is in socket type, the external electronic connector 2 is in the plug type corresponding to the socket type.

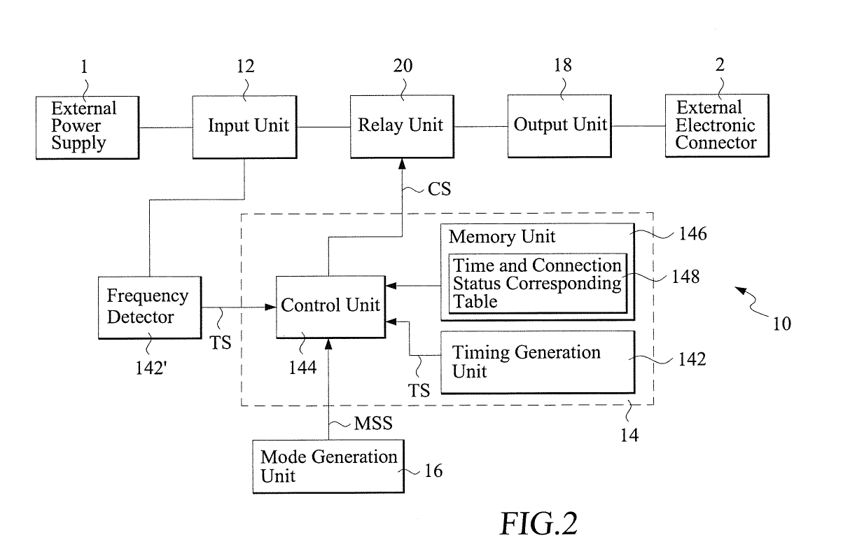

The input unit 12 is connected to the external power supply 1 to import the electricity of the external power supply 1 to the smart electronic connecting device 10. The processing module 14 has a timing generation unit 142, a control unit 144 and a memory unit 146, and the timing generation unit 142 generates a timing signal TS, and the control unit 144 generates a control signal CS, wherein the timing generation unit 142 provides the reference of the basic time units for the operation of the control unit 144. For example, the timing generation unit 142 can generate the timing signal TS to the control unit 144 via the internal time generator having an oscillator, or as shown in FIG. 2, via a frequency detector 142′ connected to the input unit 12, the timing generation unit 142 obtains the ac frequency signals (e.g. 50 Hz or 60 Hz) of the external power supply 1 to transform to the timing signal TS needed by the control unit 144.

Referring to FIG. 1 again, the mode generation unit 16 is connected to the processing module 14, and the mode generation unit 16 generates multiple mode selecting signals MSS to the control unit 144. The mode selecting signals MSS can be the manual control mode, the learning control mode and the smart control mode etc., and the mode generation unit 16 can be a switch or a bottom. It is worth notice that the mode generation unit which just needs to achieve the goal of generating multiple outputs by switch to belongs to the mode generation unit 16 mentioned in the present invention. For example, the mode switching method using single switch or bottom for pressing continuously for a while, pressing many times or pressing single time etc. also belongs to the scope of the present invention.

The manual control mode represents that the mode generation is unit 16 can directly control the turn-on connection status between the input unit 12 and the output unit 18. For example, while the manual control mode is enabled, the input unit 12 will conduct with output unit 18 such that the external power supply 1 directly provides electricity to the external electronic connector 2.

The learning control mode represents that the control unit 144 of the processing module 14 can generate at least a control signal CS to control the turn-on connection status of the relay unit 20 according to the operation status of the mode generation unit 16, and record the manual control mode proceeded by the mode generation unit 16 within a predetermined period (i.e. the recurrence period). In another word, after the learning control mode is enabled, the user still needs to decide the turn-on connection status as the manual control mode to conduct the input unit 12 and the output unit 18 or not, but the different is that the control unit 144 of the processing module 14 will synchronous record the turn-on connection status of the manual control mode, generate a time and connection status corresponding table 148 according to the turn-on connection status, and store the time and connection status corresponding table 148 in the memory unit 146. That means this function can store the turn-on connection status between the input unit 12 and the output unit 18 corresponding to the usage status in the memory unit 146. Especially, the turn-on connection status within the predetermined period can be recorded in the above-mentioned record period, e.g. 24 hours, or the user can decide the predetermined period as when to start and stop to record the turn-on connection status, or after the learning control mode is enabled, the turn-on connection status will be recorded continuously until the memory unit 146 is full.

The smart control mode represents that the processing module 14 reads the turn-on connection status stored in memory unit 146, and the turn-on connection status can recurs through the processing module 14 such that the input unit 12 and the output unit 18 can be conducted or not according to the turn-on connection status, e.g. manual control mode (also called operation habit) of the user in the past 24 hours can be recurred.

The output unit 18 is connected to the external electronic connector 2, and the output unit 18 is in socket type including two electrodes or three electrodes, etc. . . . . The relay unit 20 is connected between the output unit 12 and the output unit 18, and the relay unit 20 can be is turned on/off selectively according to the control signal CS of the control unit 144 to conduct the input unit 12 and the output unit 18. In another word, the control signal CS can further decide to conduct the input unit 12 and the output unit 18 according the mode selecting signals MSS generated from the mode generation unit 16.

Further, the memory unit 146 of the above-mentioned processing module 14 stores the turn-on connection status of the relay unit 20 in a predetermined period, and recurs the turn-on connection status in one mode of to the mode selecting signals MSS such that the mode of the mode selecting signals MSS is the smart control mode. While the control unit 144 of the processing module 14 operates in the smart control mode, the control unit 144 will read the time and connection status corresponding table 148 from the memory unit 146, and recur to generate the control signal to control the turn-on connection status of the relay unit 20 in the recurrence period according to the time and connection status corresponding table 148.

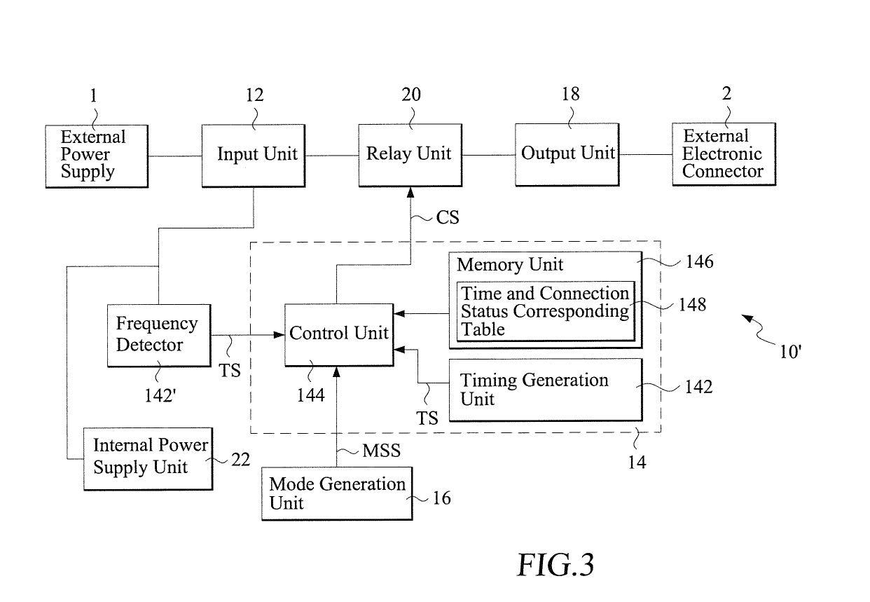

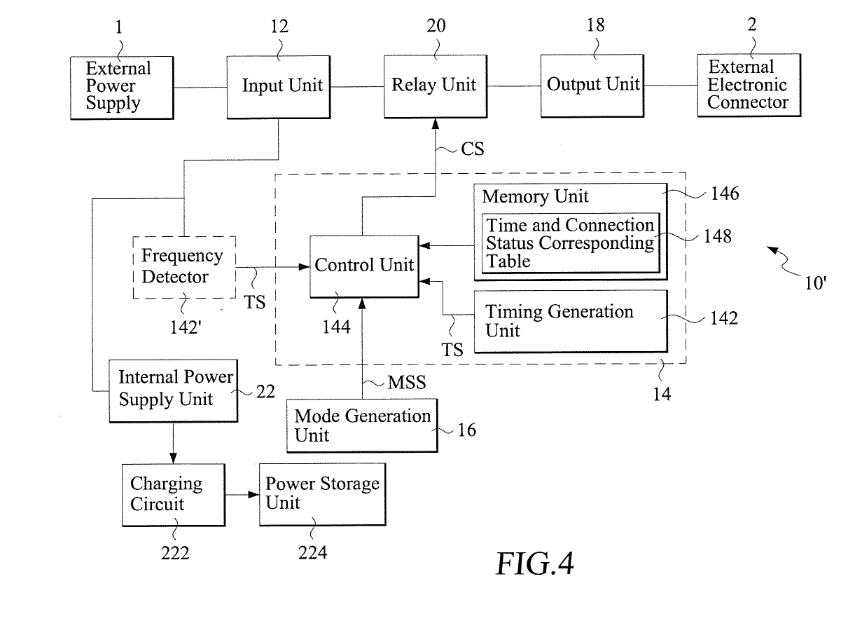

Referring to FIG. 3 and FIG. 4, FIG. 3 and FIG. 4 are the block diagrams of a smart electronic connecting device according to the second embodiment of the present invention. In this embodiment, the smart electronic connecting device 10′ includes the input unit 12, the processing module 14, the mode generation unit 16, the output unit 18 and the relay unit 20, and further includes an internal power supply unit 22 receiving the alternating current (AC) of the external power supply 1 from the input unit 12 to transform to the direct current (DC). Besides, the smart electronic connecting device 10′ further includes a charging circuit 222 and a power storage unit 224 connected to the internal power supply unit 22 such that the internal power supply unit 22 charges the power storage unit 224 through the charging circuit 222, wherein the power storage unit 222 is a rechargeable battery or a condenser.

Another design type (as shown in FIG. 5) combining an internal power supply unit 22 and a power storage unit 224 is also provided in this embodiment. When a blackout happens, the power storage unit 224 (e.g. a dry battery) provide the electricity needed by the processing module 14, and when the blackout ends, the AC mains provide the electricity through the to internal power supply unit 22.

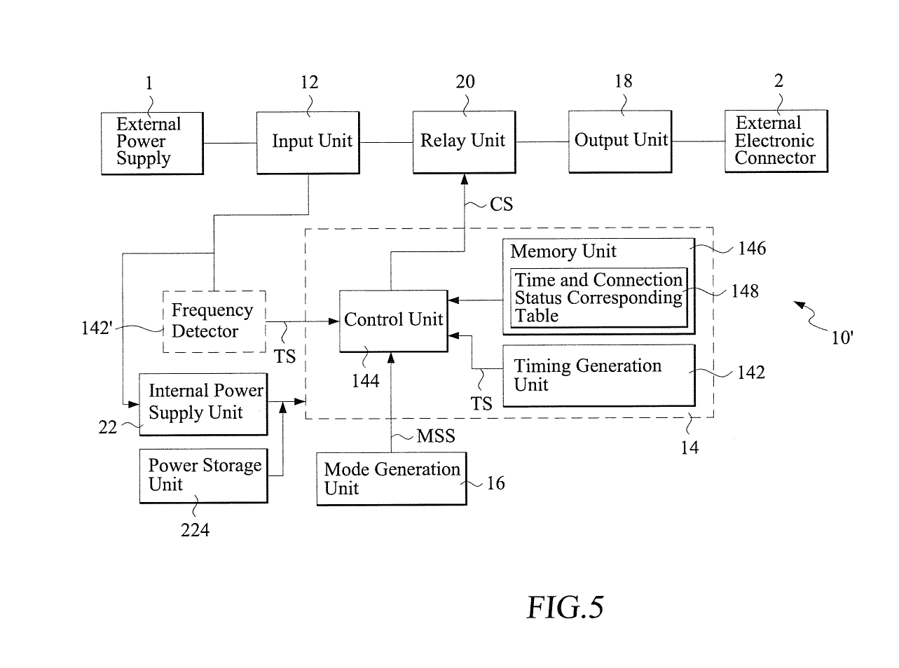

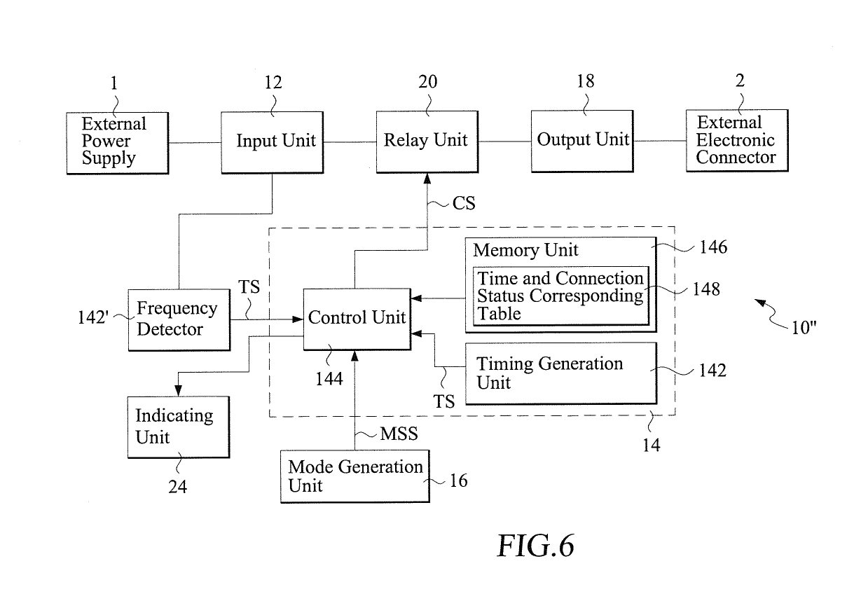

Referring to FIG. 6, FIG. 6 is a block diagram of a smart electronic connecting device according to the third embodiment of the present invention. In this embodiment, the smart electronic connecting device 10″ includes the input unit 12, the processing module 14, the mode generation unit 16, the output unit 18, the relay unit 20 and the internal power supply unit 22, and the smart electronic connecting device 10″ further includes an indicating unit 24 connected to the processing module 14 such that the indicating unit 24 (e.g. light-emitting diode, LED) generates the corresponding indicating status according to the mode selecting signals MSS, wherein the mode selecting signals MSS can be recognized according to the display status of the indicating unit 24, and the display status includes lights with different colors, flashing status or the combination of the above-mentioned status to display the mode selecting signals MSS by one or more lights. For example, the green LED ON to represent that the manual control mode of the mode generation unit is enabled, and conversely the green LED OFF to represent that the manual control mode is disabled. Further, the orange LED flashes to represent that the learning control mode is enabled, and the opposite represents the learning control mode is disabled. The orange LED ON to represent that the smart control mode is enabled, and the opposite represents the smart control mode is disabled. In another embodiment, the indicating unit 24 can be combined with the mode generation unit 16, such that the user can directly understand in which mode of the mode selecting signals MSS via the indicating unit 24 integrating with the mode generation unit 16.

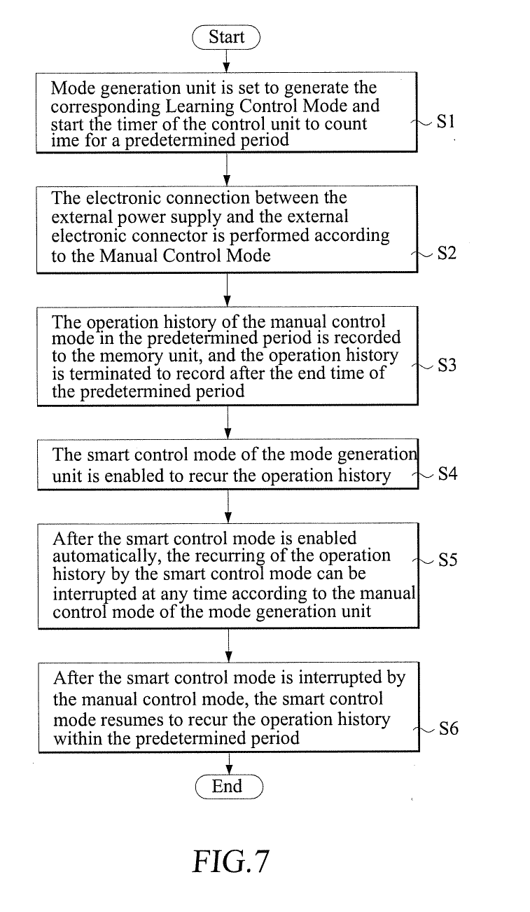

Referring to FIG. 7, FIG. 7 is a flow chart of the method of the present invention. In step S1, the mode generation unit is set to generate the corresponding learning control mode and start the timer of the control unit to count time for a predetermined period, wherein the setting of the learning control mode is finish by pressing the mode generation unit last for a setting period. For example, the learning control mode is enabled by pressing the mode generation last for 3 seconds as the setting period. In step S2, the electronic connection between the external power supply and the external electronic connector is performed according to the manual control mode of the mode generation unit. Then in step S3, the operation history of the manual control mode in the predetermined period is recorded to the memory unit, and the operation history is terminated to record after the end time of the predetermined period. Then in step S4, the smart control mode of the mode generation unit is enabled to recur the operation history.

Besides, in another embodiment, the method of the smart electronic connection further comprises step S5 after step S4. In step S5, after the smart control mode is enabled automatically, the recurring of the operation history by the smart control mode can be interrupted at any time according to the manual control mode of the mode generation unit. Besides, in step S6, after the smart control mode is interrupted by the manual control mode, the smart control mode resumes to recur the operation history within the predetermined period.

In the above-mentioned contents, the method of the smart electronic connection further indicates the manual control mode, the learning control mode and the smart control mode generated by the mode generation unit via providing the indicating unit. Besides, the method of the smart electronic connection further provides the internal power supply unit to receive the electricity from the external power supply and store the electricity to the power storage unit, wherein the power of the external power supply goes off, the power storage unit provides the electricity needed by the mode generation unit, the control unit and the indicating unit.

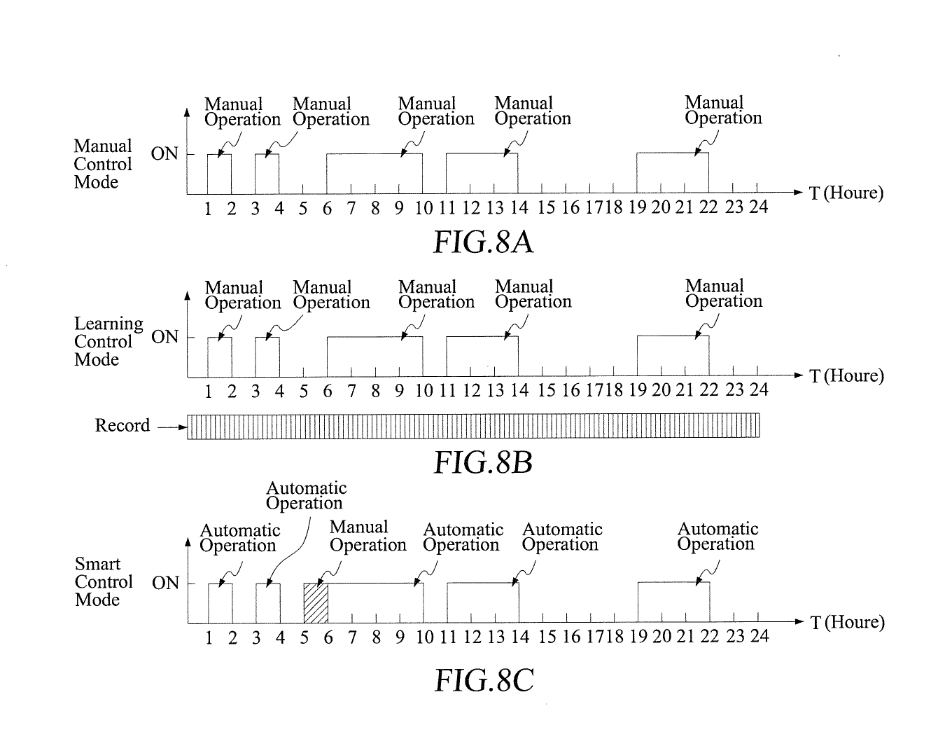

Referring to FIGS. 8A, 8B and 8C, which are the operating status diagrams of the present invention in the manual control mode, the learning control mode and the smart control mode respectively, wherein the horizontal axis represents the time, and the vertical axis represents the on/off status of the relay unit to show whether the output unit conducts with the input unit or not. The detail description is as below: in the manual control mode (as shown in FIG. 8A), the user performs the pressing to switch by the mode generation unit, for example turn on in the first hour, turn off in the second hour and so on. In the learning control mode (as shown in FIG. 8B), the user performs the pressing to switch by the mode generation unit, and at the same time, the processing module synchronous records the operation status of the user base on 24 hours as the predetermined period. In the smart control mode (as shown in FIG. 8C), the processing module automatically controls the relay unit according to the operation status recorded in the learning control mode to recur the user's operation status recorded in the learning control mode. It is worth notice that in the slash mark area, the user still can interrupt the execution of the smart control mode to perform any control manner of the manual control mode. However, when the user does not control as the manual control mode continuously, the smart control mode will still consecutively perform the original operation status of the user.

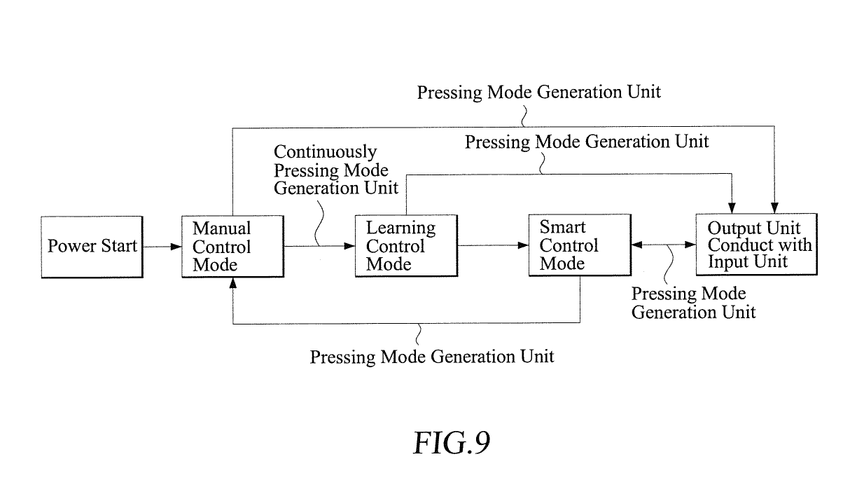

Referring to FIG. 9, FIG. 9 is a switching diagram of the present is invention among the manual control mode, the learning control mode and the smart control mode. In this embodiment, the manual control mode is enabled after starting the smart electronic connecting device, and the indicating signal is the green LED ON to represent that the input unit conducts with the output unit. The learning control mode is then enabled by pressing the mode generation unit last for 3 seconds. At this time, the indicating signal is the green LED ON plus the flashing orange LED, or the alternating green LED and orange LED with the 2 Hz cycle for 2 seconds. The manual control mode is disabled and the smart control mode is enabled when the predetermined period (e.g. 24 hours) ends or the memory unit is full. At this time, the green LED and the orange LED both ON. Then the manual control mode is enabled again by pressing the mode generation unit last for 3 seconds.

Although the present invention has been described with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A smart electronic connecting device applicable to control the electronic connection between an external power supply and an external electronic connector, the smart electronic connecting device comprising:
an input unit connected to the external power supply;
an output unit connected to the external electronic connector;
a relay unit connected between the input unit and the output unit;
a mode generation unit suitable for generating a plurality of mode selecting signals; and
to a processing module connected between the relay unit and the mode generation unit, the processing module comprising:
a control unit receiving the mode selecting signals from the mode generation unit, and operated at a learning control mode and a smart control mode according to the mode selecting signals;
a timing generation unit connected to the control unit, and suitable for generating a timing signal to the control unit; and
a memory unit connected to the control unit;
wherein when the control unit is operated at the learning control mode, the control unit generates at least a control signal to control a turn-on connection status of the relay unit according to the operation status of the mode generation unit, and the control unit generates a time and connection status corresponding table recorded in the memory unit according to the turn-on connection status within a predetermined recurrence period;
wherein when the control unit is operated at the smart control mode, the control unit recurs to generate the control signal to control the turn-on connection status of the relay unit within the recurrence period according to the time and connection status corresponding table obtained from the learning control mode.

2. The smart electronic connecting device of claim 1, further comprising an indicating unit connected to the processing module, wherein the indicating unit generates an indicating status according to the corresponding mode selecting signals.

3. The smart electronic connecting device of claim 1, further comprising an internal power supply unit receiving the alternating current (AC) of the external power supply from the input unit to transform to direct current (DC).

4. The smart electronic connecting device of claim 3, further comprising a charging circuit and a power storage unit connected to the internal power supply unit, wherein internal power supply unit charges the power storage unit through the charging circuit.

5. The smart electronic connecting device of claim 3, further comprising a power storage unit connected to the internal power supply unit, wherein when the internal power supply unit does not provide the electric power, the power storage unit provides the electric power.

6. The smart electronic connecting device of claim 5, wherein the power storage unit is a dry battery.

7. The smart electronic connecting device of claim 3, wherein the power storage unit is a rechargeable battery or a condenser.

8. The smart electronic connecting device of claim 1, wherein the timing generation unit is an internal time generator or a frequency detector.

9. The smart electronic connecting device of claim 1, wherein the mode selecting signal is a manual control mode, the learning control mode and the smart control mode.
